(19) United States
(12) Patent Application Publication
(10) Pub. No.: US 2026/0057222 A1
(43) Pub. Date: Feb. 26, 2026

(54) System

(71) Applicant: Softbank Group Corp., Tokyo (JP)

(72) Inventor: Masaki Iwanaga, Tokyo (JP)

(21) Appl. No.: 19/300,796

(22) Filed: Aug. 15, 2025

(30) Foreign Application Priority Data
Aug. 22, 2024 (JP) 2024-141426

(51) Int. Cl. G06N 3/0475; G06N 3/044

(52) U.S. Cl. CPC G06N 3/0475; G06N 3/044

(57) ABSTRACT

A system includes a processor that is configured to preprocess motion data received from biomechanical sensors, analyze the preprocessed motion data using a generative artificial intelligence to detect inappropriate movements or risks, and provide instructions to a user based on analysis results by the generative artificial intelligence.

### CROSS-REFERENCE TO RELATED APPLICATION

This application is based on and claims priority under 35 USC 119 from Japanese Patent Application No. 2024-141426 filed on Aug. 22, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Individuals with physical disabilities or elderly users who utilize prosthetic limbs, such as prosthetic arms or legs, face significant challenges in performing daily movements safely and effectively. Current systems often lack the capability to provide real-time, intelligent feedback tailored to each user's specific motion patterns, making it difficult to immediately detect inappropriate actions or potential hazards such as falls. This can result in reduced quality of life and increased risk of injury.

### SUMMARY

To address these challenges, the present invention provides a system comprising a processor that preprocesses motion data received from biomechanical sensors, analyzes the preprocessed data using generative artificial intelligence, and provides instructions to the user based on the analysis results. The system is further configured to detect real-time user movement via biomechanical sensors, utilize a generative artificial intelligence model including a recurrent neural network, and notify the user of instructions through at least one of a visual display or audio notification. The determination of inappropriate movements is performed by comparing motion data against predefined criteria, enabling prompt and tailored feedback to enhance user safety and independence.

“Biomechanical sensors” means sensors designed to detect and measure physical movements or physiological signals from the human body, particularly in relation to the operation of prosthetic devices.

“Motion data” means information or signals representing the movements, positions, angles, velocities, or related parameters of a user, as captured by biomechanical sensors.

“Preprocess” means performing operations on raw motion data to remove noise, normalize, filter, or otherwise transform the data into a standardized format suitable for further analysis.

“Generative artificial intelligence” means an AI technology or model capable of analyzing input data, learning patterns, and generating outputs such as classifications, predictions, or recommendations based on the analysis.

“Recurrent neural network” means a type of artificial neural network architecture particularly suited for processing sequential data, in which connections between neurons can form cycles to allow temporal dynamic behavior.

“User” means an individual who utilizes the system, specifically a person with physical disabilities or an elderly person making use of prosthetic limbs.

“Inappropriate movements” means user actions or motion patterns that deviate from predefined safe or recommended standards, potentially resulting in risk or inefficiency.

“Risks” means conditions or situations detected in the user's motion data that indicate a potential for harm, such as a risk of falling or accident.

“Instructions” means messages or guidance generated by the system to assist or warn the user, based on the analysis of their current movement.

“Visual display” means any graphical or textual representation presented on an electronic screen to communicate information to the user.

“Audio notification” means audible signals or spoken messages provided to the user to convey warnings, instructions, or feedback.

“Predefined criteria” means established benchmarks, rules, or patterns against which motion data are compared to determine whether a movement is appropriate or safe.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

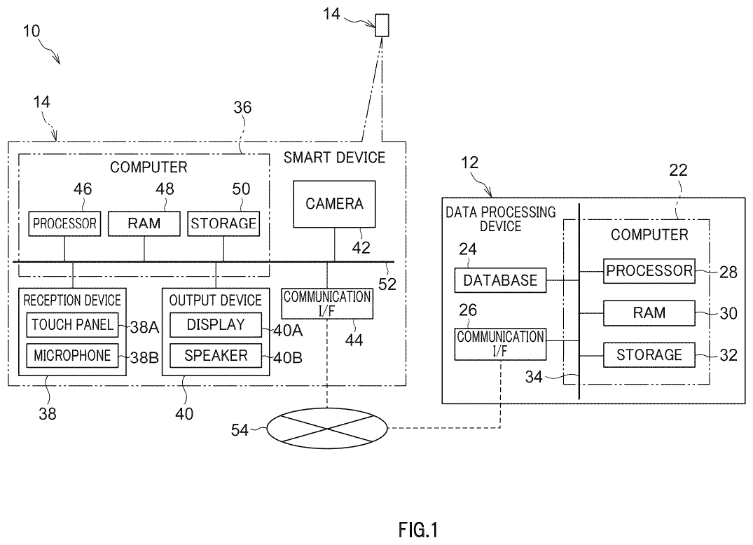

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

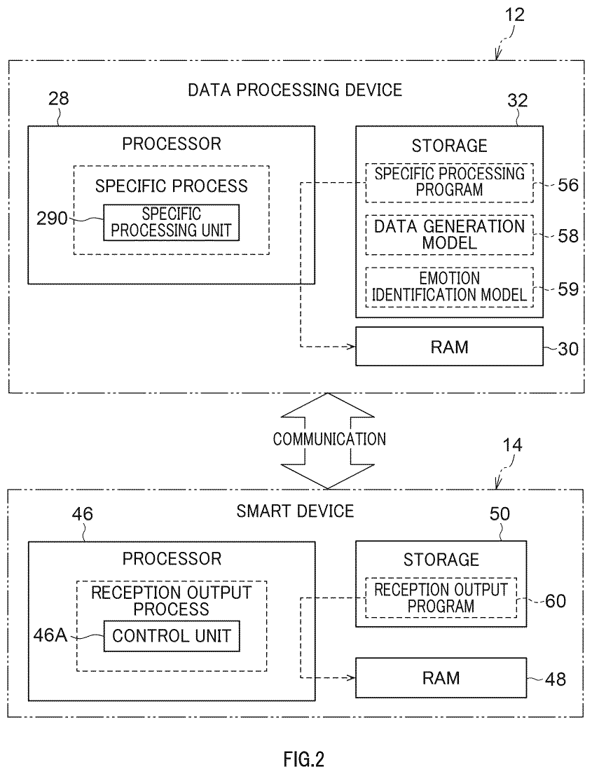

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### EXAMPLE 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for supporting disabled or elderly individuals using prosthetic devices often suffer from insufficient noise reduction and normalization of motion data, resulting in inaccurate analysis outcomes. Furthermore, conventional notification methods to users are often limited, and users might not receive timely or effective feedback, especially under certain environmental conditions. Thus, there is a need for a system that can accurately process and analyze motion data in real time, detect hazardous states or inappropriate actions, and promptly provide clear and actionable instructions to the user through various notification methods.

The specific processing by the specific processing unit 290 of the data processing device 12 in Example 1 is realized by the following means.

The present invention provides a server comprising a processor configured to receive body motion data from a biological function information acquisition device, preprocess the data to reduce noise and normalize values, analyze the processed data using a generative artificial intelligence model capable of handling time-series data, generate instructional content if hazardous or inappropriate conditions are detected, and transmit these instructions to a terminal device for visual and/or audio notification to the user. This enables highly accurate and real-time detection of unsafe or inappropriate user actions, and ensures that effective corrective instructions are promptly communicated to the user, thereby improving user safety and system usability.

The term “processor” refers to a data processing unit that executes programmed instructions to control and coordinate the operations of the system.

The term “biological function information acquisition device” refers to a device equipped with sensors to detect and collect physiological or biomechanical data from a user's body or motion.

The term “signal processing device” refers to a component or method used to preprocess, filter, and transform sensor data into a format suitable for analysis.

The term “body motion information” refers to quantitative data describing the physical movements of a user, including parameters such as angles, positions, velocities, and accelerations of body parts.

The term “noise components” refers to unwanted or irrelevant variations in sensor data that are unrelated to the user's actual motion and should be removed to obtain accurate results.

The term “standardize” refers to the processing of converting sensor data into a consistent scale or format to facilitate accurate analysis by subsequent system components.

The term “generative intelligence processing device” refers to an artificial intelligence component, such as a neural network, capable of analyzing input data and generating new information such as instructions or predictions based on learned models.

The term “time-series data” refers to sequential data points collected or represented over time, essential for analyzing dynamic and temporal patterns in user motion.

The term “hazardous state” refers to a detected condition that presents a risk of harm or injury to the user based on the analysis of body motion information.

The term “inappropriate action” refers to a detected movement or behavior that deviates from predetermined safe or proper motion standards.

The term “instruction content” refers to specific guidance or messages automatically generated by the system to prompt corrective actions by the user.

The term “terminal device” refers to an electronic device capable of receiving and presenting information to the user, such as a mobile terminal or computing device.

The term “display device” refers to hardware or means for visual presentation of information to the user, such as a screen.

The term “audio output device” refers to a component capable of generating sound or voice notifications for the user, such as a speaker or headset.

The term “user” refers to an individual who utilizes the prosthetic or motion support system and receives feedback or notifications from the system.

The term “response information” refers to data related to the user's reaction or correction of motion following receipt of a system notification.

One embodiment of the present invention relates to a system designed to monitor and support the motion of users, including individuals using prosthetic devices, in real time. The system comprises a biological function information acquisition device, such as a wearable sensor equipped with an accelerometer and gyroscope, a signal processing device such as a terminal (for example, a mobile phone or tablet), and a server comprising a processor configured to analyze and interpret the acquired data using a generative artificial intelligence model.

The sensor device is attached to the user's body or prosthesis. This device continuously collects body motion information, such as angular position, acceleration, and orientation data. The terminal is equipped with software (for example, Python scripts utilizing libraries such as NumPy and SciPy) to preprocess the raw sensor signals. Preprocessing includes removing noise components from the collected physical motion data and standardizing the values to a consistent format suitable for advanced analysis.

After preprocessing, the terminal transmits the cleaned and standardized data to the server through a communication network. The server host platform can utilize general-purpose hardware, such as a computer workstation or a cloud server, running generative artificial intelligence software (for example, models implemented with machine learning frameworks such as TensorFlow and Keras).

On the server, a generative intelligence processing device analyzes the input time-series data. The server employs a recurrent neural network or similar artificial neural network to recognize patterns in the user's motion and to dynamically judge whether a hazardous state, such as an increased risk of falling, or an inappropriate action, such as incorrect motion with a prosthesis, is occurring. Upon detection of such conditions, the server generates instructional content, which consists of prompt sentences to be communicated to the user in natural language.

The instruction content is transmitted from the server to the terminal. The terminal notifies the user either visually, through a display (such as by showing a message on a mobile device screen), or aurally, through an audio output device (such as by playing a spoken message via speaker or headset).

For user feedback, the user acknowledges or reacts to the instructions, such as by changing their motion, and the system can capture and record response information, which can be used for further data analysis or system improvement.

Specific example: While the user is walking with a prosthetic leg, the biological function information acquisition device detects signs of gait instability. The terminal processes this data and sends standardized information to the server. The server, using a generative AI model powered by a recurrent neural network, analyzes the data and determines that there is a high risk of the user falling. The server generates an instruction such as:

“Risk of falling detected. Please adjust your posture and slow your walking pace.”

This message is displayed on the terminal and announced to the user through a speaker.

Example prompt sentence used by the server:

“Analyze the user's walking pattern in real time. If instability is detected, generate an instruction for the user, such as: ‘Risk of falling detected. Please adjust your posture and slow your walking pace.’”

By implementing the invention in this manner, the system achieves precise, real-time detection and communication of potentially dangerous or inappropriate user actions, thereby improving user safety and providing valuable support for those utilizing motion-assistive devices.

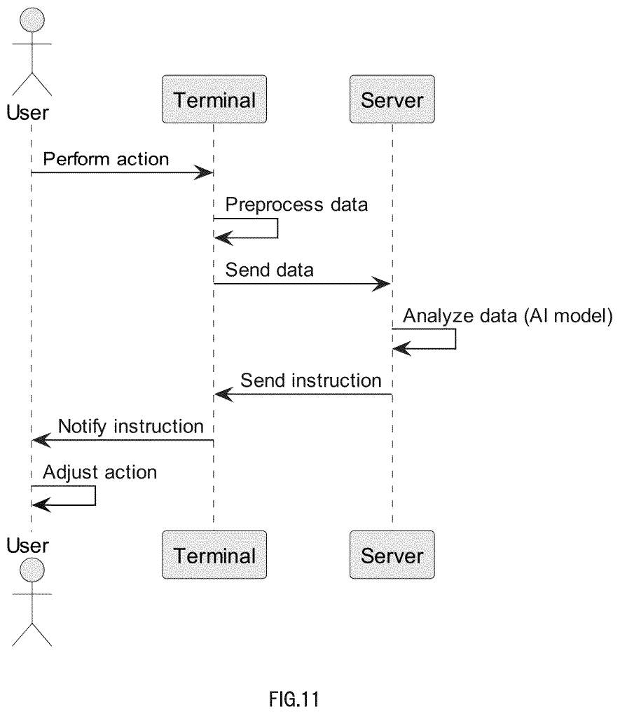

The following describes the processing flow using FIG. 11.

### Step 1

The user performs a physical action, such as walking with a prosthesis or lifting an object with a prosthetic limb.

Input: The user's voluntary motion.

Output: Real-time raw data generated by a biological function information acquisition device attached to the user, including acceleration, angular position, and orientation.

### Step 2

The terminal receives the raw motion data from the biological function information acquisition device via wireless communication.

Input: Raw sensor data containing various noise and unstandardized values.

The terminal stores the incoming data and prepares it for preprocessing.

Output: Saved raw sensor data on the terminal.

### Step 3

The terminal preprocesses the raw sensor data using a software application, such as a Python script with NumPy and SciPy libraries.

Input: Raw sensor data.

The terminal removes noise components by applying filters (for example, a low-pass filter), and standardizes the data by normalizing ranges or scaling features to a uniform format.

Output: Preprocessed and standardized motion data.

### Step 4

The terminal sends the preprocessed and standardized motion data to the server through a secure communication network.

Input: Preprocessed motion data from the terminal's local storage or memory.

The terminal creates a structured data package, such as a JSON object, and transmits it to the server using a communication protocol (e.g., HTTPS).

Output: Preprocessed motion data received by the server.

### Step 5

The server analyzes the received data using a generative AI model, such as a recurrent neural network implemented with a machine learning framework.

Input: Preprocessed and standardized motion data sent from the terminal.

The server runs the data through the generative AI model for inference, identifying anomalous patterns, hazardous states, or inappropriate actions relative to stored motion templates or learned criteria.

Output: Detected outcomes indicating presence or absence of abnormality, and corresponding analysis results.

### Step 6

The server generates an instruction based on the analysis result, composing a prompt sentence to guide the user.

Input: Analysis result from the generative AI model, specifying the detected state or issue.

The server creates a relevant and actionable instruction such as “Risk of falling detected. Please adjust your posture and slow your walking pace.”

Output: Instruction message prepared as text for user notification.

### Step 7

The server transmits the generated instruction message to the terminal over the network.

Input: Instruction message from the server's internal process.

The server sends this message in a format compatible with the terminal's display and audio output modules.

Output: Instruction message delivered to the terminal.

### Step 8

The terminal notifies the user by displaying the instruction message on the screen and optionally playing the message as audio through a speaker or headset.

Input: Instruction message received from the server.

The terminal executes user interface processes to present the message visually and/or with synthesized speech.

Output: Notification of the instruction to the user via display and/or audio.

### Step 9

The user observes the instruction and adjusts their action accordingly for improved safety or correctness.

Input: Instruction presented on the terminal.

The user modifies their movement, such as correcting posture or slowing walking speed.

Output: Improved or corrected user motion, which can be further monitored by the system.

### APPLICATION EXAMPLE 1

Description follows regarding a flow of the specific processing in an Application Example 1. The units of the system described below are implemented by the data processing device 12 and the smart device 14. The data processing device 12 is called a “server” and the smart device 14 is called a “terminal”.

Accurate real-time detection and notification of abnormal states or risk conditions based on a user's biometric or physical activity information remains a significant technical challenge, particularly when it comes to processing complex time-series data and providing appropriate, psychologically considerate feedback. Conventional systems often lack the capability to analyze both physiological and emotional states in an integrated fashion, which is essential for improving safety and user well-being, especially in applications involving autonomous vehicles or assistive prosthetic devices.

The specific processing by the specific processing unit 290 of the data processing device 12 in Application Example 1 is realized by the following means.

The present invention provides a server comprising a processor configured to preprocess time-series data acquired from a biometric measurement device, analyze the preprocessed data using a generative artificial intelligence model to detect abnormal states or risk conditions, generate prompt sentences for the artificial intelligence model, generate notification content based on both analytical and emotional identification results, output the notification content to a user by at least one of a visual and an audio output unit, and recognize the user's emotional state to adapt further notifications. This enables accurate, real-time detection of anomalies or risks, and delivers adaptive and psychologically supportive feedback to the user by simultaneously analyzing both physiological and emotional data.

The term “processor” refers to an information processing unit, including but not limited to one or more central processing units (CPUs), microcontrollers, or other programmable hardware capable of executing software instructions for data acquisition, analysis, and system control.

The term “time-series information” refers to data representing measurements or observations of a variable or set of variables collected sequentially over time at regular or irregular intervals.

The term “biometric measurement device” refers to a generic measurement apparatus configured to acquire physiological or biological signals from a user, such as heart rate, body temperature, electromyographic signals, or motion data.

The term “preprocess” refers to the operation of performing data cleaning, filtering, normalization, transformation, or other signal enhancement procedures on acquired raw data in order to make it suitable for analytical processing.

The term “generative artificial intelligence model” refers to a computational model utilizing machine learning or deep learning architectures, including recurrent neural networks or other neural network-based systems, which can generate predictions, classifications, or new data based on input information.

The term “abnormal state or risk condition” refers to a physiological or physical event, pattern, or parameter that deviates from a prespecified reference or normal range, indicating the possibility of danger, malfunction, or undesired outcome for the user.

The term “prompt sentence” refers to a structured textual or symbolic input provided to a generative artificial intelligence model to guide the model's processing, inference, or output generation.

The term “notification content” refers to the generated message, instruction, alert, or feedback, including its linguistic, visual, or audio form, intended to communicate analysis results or advice to the user.

The term “visual output unit” refers to any display or presentation device or component capable of rendering text, graphics, or visual indicators to the user.

The term “audio output unit” refers to any device or component capable of producing sound, speech, or audio messages perceivable by the user.

The term “emotion estimation device” refers to a generic sensor, camera, microphone, or similar apparatus, or a combination thereof, configured to acquire raw data for determining a user's emotional state based on features such as facial expressions, voice characteristics, or physiological changes.

The term “feature information” refers to the set of extracted attributes, parameters, or statistical descriptors derived from the raw data of biometric or emotional sensors, which are used for analysis and classification purposes.

The term “emotional state” refers to the condition of the user's psychological or affective status, such as stress, anxiety, calmness, or other emotions, as inferred from biological, audio, or visual data analyzed by the system.

An embodiment of the present invention provides a system comprising a processor, a biometric measurement device, a terminal device, and an emotion estimation device, with functional cooperation between these components for real-time monitoring and user feedback. The biometric measurement device acquires time-series information related to the user's physiological or physical activity. This device can include, for example, a heart rate sensor, a skin temperature sensor, an electromyography sensor, or a motion sensor worn or attached to the user's body. The terminal device receives raw data from the biometric measurement device using wireless or wired communication protocols, such as Bluetooth, Wi-Fi, or a direct electrical connection.

The processor in the terminal device performs preprocessing of the received data. The terminal device executes software implemented, for example, in Python, C, or embedded system language, to remove noise from the data using algorithms such as a moving average filter, and normalizes the values for input to a machine learning model. The preprocessed data is structured into time-series arrays with associated timestamps.

Subsequently, the terminal device transmits the preprocessed data to a server incorporating the system's processor. The server, preferably implemented as a general-purpose computing device, is equipped with one or more CPUs or other processing units and runs software frameworks for artificial intelligence computation, such as TensorFlow, PyTorch, or Keras. The server is configured to employ a generative artificial intelligence model, such as a deep learning recurrent neural network, for analyzing the received time-series data. The server generates a prompt sentence as input for this generative artificial intelligence model, for instance:

“Given this sequence of heart rate, skin temperature, and motion data for the last 60 seconds, predict the probability of an anomaly and output an appropriate notification message.”

The generative AI model processes the preprocessed physiological data along with the prompt sentence to determine the probability of an abnormal state or risk condition.

Moreover, when the emotion estimation device, such as a camera or microphone embedded in the terminal device, detects the user's facial expressions, voice, or other features, the server analyzes these features to recognize the user's emotional state. Software for feature extraction may utilize conventional image processing libraries or speech analysis tools, and emotion recognition may be performed by an emotion classification model trained using the aforementioned AI frameworks.

Based on the results of physiological and emotional analysis, the server generates notification content. The notification can be adapted according to the user's emotional state, for example: “Analyze these facial feature vectors and classify the user's emotional state. If the user is anxious, adapt your feedback to provide reassurance.”

Notification content, such as “Abnormal heart rate detected. Please take a break,” or “There is a risk of falling. Please walk slowly and carefully,” is sent back to the terminal device. The terminal device presents the notification on a visual output unit, such as a display, and/or on an audio output unit, such as a speaker using a text-to-speech engine (for example, Google Text-to-Speech or eSpeak).

As a concrete example, suppose a user is operating an autonomous vehicle or walking with a prosthetic limb. When a sudden abnormality in the user's physiological signals is detected by the biometric measurement device, the terminal device preprocesses the data and the server's generative AI model identifies the anomaly. The server composes an appropriate prompt sentence and outputs a psychological condition-tailored instruction, such as: “Your heart rate is very high. Please relax, stop for a break, and contact a doctor if you feel unwell.” The terminal device delivers the notification through both display and spoken message, ensuring the user is promptly informed and can respond for increased safety and well-being.

Thus, the system can be realized using combinations of commercially available sensors (e.g., generic heart rate monitors, generic temperature sensors, generic EMG sensors), computing hardware (generic smartphones, embedded computers, general-purpose servers), and machine learning or deep learning software frameworks, with programming languages and libraries chosen according to implementation requirements. This embodiment supports flexible extension to various applications involving real-time user monitoring and adaptive feedback powered by generative AI models.

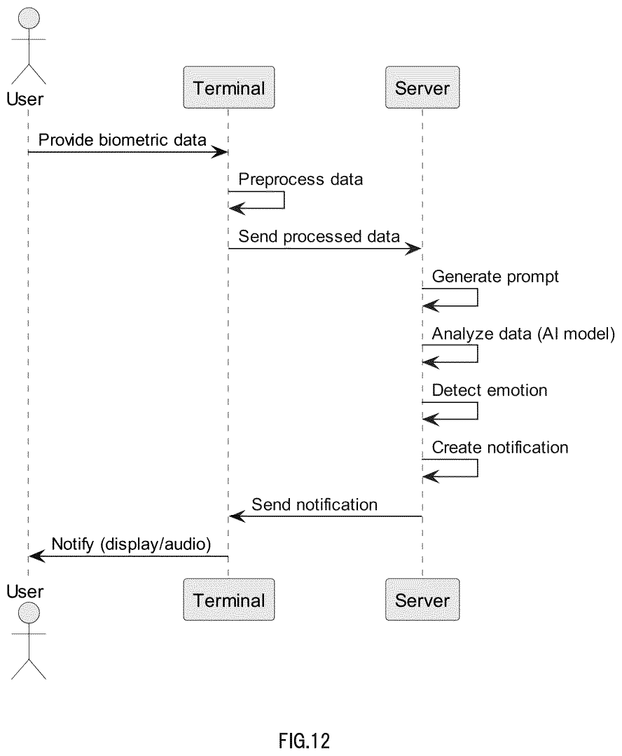

The following describes the processing flow using FIG. 12.

### Step 1

User wears or attaches a biometric measurement device, such as a heart rate sensor, skin temperature sensor, or EMG sensor.

Input: User's physiological signals (e.g., heart rate, skin temperature, muscle activity) in analog or digital form.

Output: Raw sensor data as a sequence of time-stamped values.

### Step 2

Terminal receives the raw sensor data from the biometric measurement device via wired or wireless communication such as Bluetooth or Wi-Fi.

Input: Raw sensor data stream.

Output: Acquired data packets containing time-series physiological information.

### Step 3

Terminal preprocesses the received sensor data by applying noise removal algorithms, such as moving average filtering, and normalizes the data to standard scales for machine learning compatibility.

Input: Acquired data packets from sensors.

Operation: Terminal removes outliers, filters the data, and rescales the values to a normalized range.

Output: Cleaned and normalized time-series data structured into arrays with timestamps.

### Step 4

Terminal transmits the preprocessed, normalized data to the server using secure data protocols such as HTTPS, MQTT, or WebSocket.

Input: Preprocessed time-series data from terminal's internal memory or buffer.

Operation: Terminal packages the data into structured JSON and establishes communication with the server to send the package.

Output: Structured time-series data received at the server side.

### Step 5

Server generates a prompt sentence appropriate for the analysis context, such as “Given this sequence of heart rate, skin temperature, and motion data for the last 60 seconds, predict the probability of an anomaly and output an appropriate notification message.”

Input: Structured time-series data and pre-defined prompt templates for the generative AI model.

Operation: Server combines incoming data indices and prompt templates to generate a specific prompt sentence.

Output: Prompt sentence and formatted analysis input.

### Step 6

Server analyzes the preprocessed data by inputting both the data and the generated prompt sentence into a generative AI model, such as a recurrent neural network implemented in TensorFlow or PyTorch.

Input: Preprocessed data arrays and the prompt sentence.

Operation: Server feeds the data and prompt to the AI model, which computes probabilities or classifies the user's state (normal, anomaly, risk, etc.).

Output: Analytical results indicating identified user state or risk level.

### Step 7

Server receives data from the emotion estimation device, such as facial image data or voice recordings, and processes this input to determine the user's emotional state using an emotion recognition algorithm.

Input: Raw data from the emotion estimation device (e.g., camera or microphone feed).

Operation: Server extracts relevant features such as facial emotion vectors or vocal tone, and classifies emotional state (e.g., anxious, calm, etc.).

Output: Identified user emotional state.

### Step 8

Server generates notification content by combining the analytical results from the generative AI model and the user's emotional state. If risk or anomaly is detected, the content is tailored to both the situation and emotional state, for example, “Abnormal heart rate detected. Please take a break. You seem anxious. Please try to relax.”

Input: Analytical results from the AI model and the recognized emotional state.

Operation: Server applies predefined notification logic and adaptive templates to combine the results into a concise, user-appropriate message.

Output: Notification message for the user.

### Step 9

Server sends the notification message to the terminal for delivery to the user.

Input: Notification message content (e.g., in text or audio format).

Operation: Server establishes a secure connection with the terminal and transmits the message as a data packet.

Output: Notification message received at the terminal.

### Step 10

Terminal outputs the notification to the user through a visual output unit (such as an LCD display) and/or an audio output unit (such as a speaker via a text-to-speech engine).

Input: Notification message in text and/or audio format.

Operation: Terminal displays the message on screen and/or uses text-to-speech software to read the message out loud; may also activate a vibration motor for urgent alerts.

Output: Delivered notification that informs the user of their condition and the necessary action.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional operation support systems for prosthetic devices primarily analyze user motions to provide instructions, but they lack the ability to consider the user's real-time emotional state. As a result, these systems cannot alleviate the psychological burden experienced by users, such as individuals with physical disabilities or elderly people, when using prosthetic limbs. This can lead to increased stress, unsafe operations, and reduced quality of life.

The specific processing by the specific processing unit 290 of the data processing device 12 in Example 2 is realized by the following means.

The present invention provides a server comprising a processor configured to preprocess motion and emotion information acquired from a biometric information acquisition device, analyze the preprocessed motion information using a generative machine learning model, recognize the user's emotional state in real time, generate user instructions adjusted according to both the motion analysis and the recognized emotional state, and notify these instructions to the user via an information terminal. This enables real-time support that not only enhances physical safety but also reduces psychological stress by providing context-aware instructions tailored to both the physical and emotional state of the user.

The term “processor” refers to an electronic circuit or computing device capable of executing instructions and performing data processing tasks necessary to implement system functions.

The term “biometric information acquisition device” refers to a hardware apparatus, such as a sensor unit, that detects or measures human physiological or behavioral characteristics, including but not limited to motion, posture, facial expression, or voice data.

The term “motion information” refers to data that represents the movement, position, angle, or dynamic state of a user, typically captured through sensors such as accelerometers or gyroscopes.

The term “emotion information” refers to data indicative of the user's psychological or emotional state, derived from analysis of facial expressions, voice tone, or other physiological signals.

The term “preprocess” refers to the operation of filtering, normalizing, converting, or otherwise preparing raw sensor data to a format suitable for further analysis by machine learning or other computational models.

The term “generative machine learning model” refers to a computational model, such as a neural network, trained to analyze input data, extract features, and predict or generate outputs related to specific patterns, states, or risks.

The term “neural network” refers to a type of computational model inspired by the structure and function of biological neural networks, consisting of interconnected processing elements capable of learning complex patterns from data.

The term “time-series data analysis” refers to the processing and evaluation of data that is collected in sequence over time, enabling the identification of temporal patterns, changes, or anomalies.

The term “instruction content” refers to guidance or advice generated by the system, which is formulated based on the detected condition or state of the user and tailored to address both physical and emotional aspects.

The term “information terminal” refers to an electronic device, such as a mobile device, tablet, or wearable device, which is capable of receiving, displaying, and outputting information to the user.

The term “real-time” refers to the capability of the system to process data and provide outputs or feedback with minimal delay, effectively responding to user state or events as they occur.

An embodiment of the invention is described in the following manner.

The server, which includes a processor, is designed to provide real-time operational and psychological support to users who operate assistive devices such as prosthetic arms or legs.

The system comprises a biometric information acquisition device, an information terminal, and a communication network connecting these elements to the server.

The biometric information acquisition device may consist of various sensors, including accelerometers, gyroscopes, cameras, and microphones. These sensors are attached to the user's body or prosthetic device and are capable of measuring parameters such as motion, position, rotation, facial expressions, and voice tone. Typical hardware options for these components include general-purpose accelerometer modules, gyroscope modules, digital cameras, and microphones.

The terminal, such as a mobile device, tablet, or wearable device, is configured to receive the sensor data via short-range wireless communication (for example, Bluetooth Low Energy).

Upon receiving the data, the terminal performs preprocessing. This involves removing noise from sensor signals, applying normalization techniques such as min-max scaling to map values into a standard range, and extracting features if necessary from facial video or audio data. Suitable software tools for this purpose include signal processing libraries (such as SciPy), normalization toolkits (such as scikit-learn), and face/voice feature extraction using frameworks like OpenCV or corresponding platform libraries.

The terminal then sends the preprocessed motion and emotion-related information to the server via internet communication using secure protocols such as HTTPS.

The server processes the received data using a generative AI model implemented by a machine learning framework, such as TensorFlow or PyTorch. The server analyzes time-series motion data with a neural network (for example, a recurrent neural network or RNN) to detect abnormalities, predict risks (such as falls or improper motion), and assess the user's operational safety. The server further evaluates emotion-related information with an emotion recognition module, using a convolutional neural network (CNN) or another machine learning algorithm trained for facial expression and speech tone analysis.

Based on both the motion analysis and the recognized emotional state, the server generates adaptive instruction content for the user. The server may use a prompt sentence tailored to the user's current physical and psychological condition to generate an appropriate advisory message. The server then sends the instruction to the user's terminal via a real-time communication channel such as a WebSocket connection.

The terminal receives this guidance and immediately notifies the user via visual display (for example, on a mobile device or wearable screen) and/or voice output (utilizing a text-to-speech engine suitable for the device platform).

By adopting the above-described configuration, the system enables the user to receive context-appropriate operational guidance and psychological support, thereby reducing stress and increasing safe use when operating an assistive device.

Specific examples include the following:

### EXAMPLE 1

Prompt sentence: “User is walking using a prosthetic leg and instability is detected by the sensors. Terminal sends this data to the server. The generative AI model analyzes the data and identifies a risk of falling. The facial expression reveals anxiety. Please generate an appropriate instruction.”

Possible instruction: “There is a risk of falling. Please adjust your posture slowly and remain calm.”

### EXAMPLE 2

Prompt sentence: “User performs an improper action while lifting an object with a prosthetic arm. The sensors detect this and the data is sent to the server. The generative AI model detects inappropriate movement. The user's voice tone analysis recognizes frustration. Please generate an appropriate instruction.”

Possible instruction: “Your movement was not appropriate. Please take a deep breath and try again calmly.”

Through this embodiment, the server, terminal, and biometric information acquisition device work in concert to ensure not only the safety of the user but also to provide personalized psychological support dependent on real-time contextual assessment.

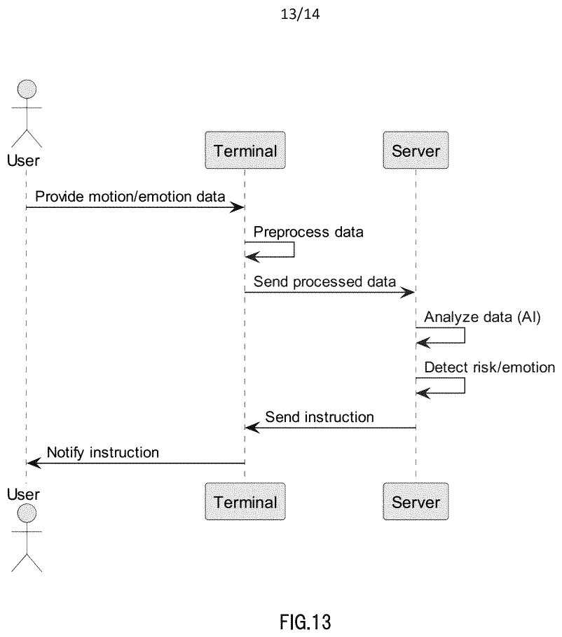

The following describes the processing flow using FIG. 13.

### Step 1

The biometric information acquisition device collects real-time motion and emotion data from the user.

Input: User's motion, posture, facial expressions, and voice while using a prosthetic device.

Processing: The biometric information acquisition device, such as accelerometers, gyroscopes, cameras, and microphones, senses and digitizes physical and emotional parameters at regular intervals.

Output: Raw sensor data streams, including acceleration values, angular velocity, facial image frames, and audio samples.

### Step 2

The terminal receives the data from the biometric information acquisition device and performs preprocessing.

Input: Raw sensor data streams from the biometric information acquisition device.

Processing: The terminal removes noise from the sensor signals using a digital filter, normalizes the numerical data with min-max scaling for uniform range mapping, and extracts emotion-related features from video/audio using face and voice analysis algorithms.

Output: Cleaned and normalized motion and emotion feature arrays suitable for further processing.

### Step 3

The terminal transmits the preprocessed data to the server over a secure wireless network connection.

Input: Preprocessed motion and emotion feature arrays.

Processing: The terminal serializes the data into structured messages (e.g., JSON), attaches session identifiers, and uses HTTPS to send the data to a designated API endpoint on the server.

Output: Securely transmitted preprocessed data received by the server.

### Step 4

The server analyzes the preprocessed motion data using the generative AI model.

Input: Preprocessed motion feature arrays from the terminal.

Processing: The server feeds the motion data into a recurrent neural network model, which performs time-series pattern recognition to detect abnormal or risky operations by comparing the data sequence against learned safe and unsafe action profiles.

Output: A risk assessment result indicating abnormality or potential danger in user operation.

### Step 5

The server recognizes the user's emotional state using the emotion recognition module.

Input: Preprocessed emotion-related data, including facial image frames and voice signal features.

Processing: The server applies a facial expression recognition algorithm and a voice tone analysis model to classify the user's emotional state (such as anxiety, frustration, or calmness).

Output: A detected emotional status label for the current user state.

### Step 6

The server generates an instruction for the user based on both risk assessment and emotional status using a prompt sentence.

Input: Risk assessment result and emotional status label.

Processing: The server constructs a prompt sentence that incorporates the user's physical and emotional status, then generates an adaptive instruction (for example, using natural language processing models) tailored to the particular condition and psychological needs of the user.

Output: Instruction text designed to guide and support the user appropriately.

### Step 7

The server transmits the generated instruction to the terminal via a real-time communication channel.

Input: Generated instruction text.

Processing: The server sends the message to the terminal using a real-time protocol such as a WebSocket connection, ensuring minimal delay.

Output: Instruction text reliably delivered to the terminal.

### Step 8

The terminal presents the instruction to the user in both visual and audio formats.

Input: Instruction text received from the server.

Processing: The terminal displays the message on a graphical interface and uses a text-to-speech engine to read the instruction aloud to the user. Optionally, the terminal may trigger a vibration or other tactile feedback for immediate attention.

Output: User receives the instruction for corrective action and psychological support.

### Step 9

The user acts upon the instruction provided by the terminal.

Input: Guidance and support message presented by the terminal.

Processing: The user adjusts behavior as needed, such as correcting their posture or calming themselves, based on the system's guidance.

Output: User's improved operational safety and reduced psychological burden.

### APPLICATION EXAMPLE 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional systems for monitoring and analyzing user motions with biosignal sensors in operating environments, such as those involving robotic machinery, are only capable of detecting unsafe or inappropriate actions. However, they are unable to provide real-time psychological support to users by considering the user's emotional state.

Consequently, there is a need for a solution that not only analyzes motions for safety but also recognizes emotional conditions and delivers suitable guidance to both enhance safety and reduce psychological burden in real time.

The specific processing by the specific processing unit 290 of the data processing device 12 in Application Example 2 is realized by the following means.

The present invention provides a server comprising a processor configured to preprocess motion information acquired from a biosignal detection device, analyze the preprocessed motion information using a generative artificial intelligence model, acquire and analyze user emotional information using an emotion analysis engine, generate instruction sentences for the user based on both motion and emotional analysis results, and notify the user of the instruction sentences via an output device in a visual or auditory modality. This enables the system to simultaneously detect operational risks, recognize the user's emotional state, and provide timely, context-aware guidance, thereby improving both operational safety and psychological comfort for the user.

The term “processor” refers to a hardware or software computing unit that executes instructions to perform various data processing tasks, including data acquisition, analysis, and control functions, as specified in the system.

The term “biosignal detection device” refers to a device or sensor that acquires physiological or biomechanical information, such as movement, muscle activity, or other bodily signals, from a user in real-time.

The term “motion information” refers to data representing the physical movements or postures of a user, obtained from the biosignal detection device.

The term “preprocess” refers to operations performed on raw data to enhance its quality for analysis, including noise removal, normalization, and conversion to a standardized format.

The term “generative artificial intelligence model” refers to a machine learning-based computational model capable of analyzing input data, such as motion information, to detect patterns, assess risks, and generate appropriate outputs based on learned data representations.

The term “emotion analysis engine” refers to a computational system or software module that analyzes signals, such as images or audio, to determine or classify the emotional state of a user in real-time.

The term “instruction sentence” refers to a textual or verbal message generated by the processor, containing guidance, alerts, or recommendations to the user based on analysis results.

The term “output device” refers to a component, such as a display, speaker, or other interface, that presents or communicates instruction sentences and other information to the user.

The term “visual or auditory modality” refers to the presentation of information to the user either visually, such as on a display, or audibly, such as through a speaker.

An embodiment for carrying out the present invention is described below.

The system comprises a server, a terminal, a biosignal detection device, and output equipment such as a display and a speaker. The biosignal detection device, for example, incorporates an inertial measurement unit (IMU) or an electromyography (EMG) sensor, which is attached to the user's body or clothing. This device acquires real-time motion information by detecting physical movements or muscle activities from the user while operating machinery, such as a robotic arm in an industrial setting.

The terminal receives raw motion data from the biosignal detection device. The terminal preprocesses this raw data using software libraries such as NumPy and Pandas, performing operations such as noise removal, normalization, and data formatting. After preprocessing, the terminal forwards the processed motion information to the server using a wired or wireless communication protocol, for example, HTTPS or WebSocket.

The server is implemented as a computing platform equipped with a processor capable of running artificial intelligence and data analytics software. The server includes a generative AI model built with TensorFlow or Keras, which analyzes the preprocessed motion data. This model assesses whether the user's movements are safe or involve inappropriate or dangerous actions.

The server also includes an emotion analysis engine. This engine analyzes emotional data acquired from the user, such as visual data from a camera (for facial expression recognition using OpenCV) or audio data from a microphone (for voice tone recognition using PyTorch or similar frameworks). The emotion analysis engine determines the user's emotional state, such as anxiety, stress, calmness, or frustration.

Based on the results of both the motion analysis and the emotional analysis, the server generates an instruction sentence (prompt sentence) tailored to the specific user context. The instruction sentence may be generated automatically or selected from a predefined set. The server transmits this prompt sentence to the terminal.

The terminal receives the instruction sentence and communicates it to the user via the output device. For visual notifications, the instruction is shown on a display. For audio notifications, the terminal converts the instruction sentence into speech using a text-to-speech library such as pyttsx3, and broadcasts the message using speakers.

The user receives the instruction sentence and responds accordingly. For example, upon receiving a warning about dangerous posture, the user may adjust their body alignment or modify their actions to increase safety and efficiency.

Concrete examples of instruction sentences generated and presented by the system include:

“It is dangerous. Please slowly adjust your posture.”

“Your movements are inappropriate. Please calm down and check again.”

“You seem stressed. Please take a short break before proceeding.”

“Great job! Your movement is correct and safe.”

With this configuration, the system can provide both physical and psychological support to users engaged in complex operational tasks, such as those found in factories, medical rehabilitation, or other high-risk environments. This enhances user safety, improves efficiency, and reduces the psychological burden by delivering real-time, situation-specific guidance derived from both physical and emotional state analysis.

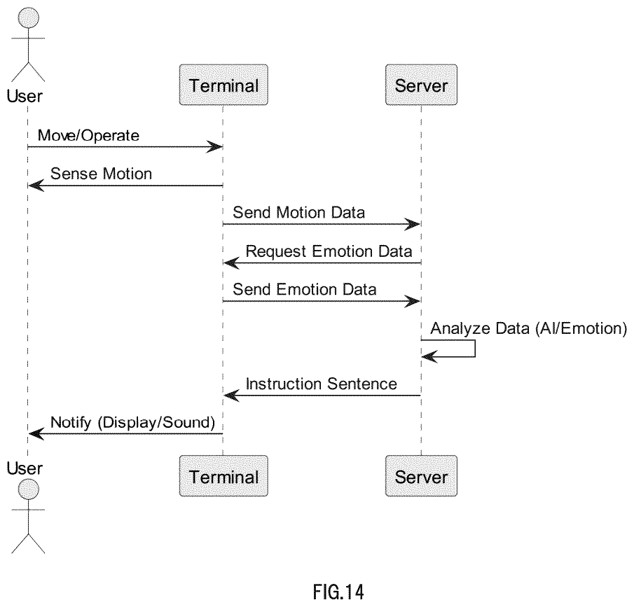

The following describes the processing flow using FIG. 14.

### Step 1

The user performs a physical task, such as manipulating a robotic arm or moving an object in an operational environment.

Input: User's real-time body movement.

Output: Biomechanical signals (such as acceleration, angle, muscle activity) captured by the biosignal detection device.

The biosignal detection device detects the user's movement and generates raw data that reflects the user's posture or actions.

### Step 2

The terminal receives the raw biomechanical data from the biosignal detection device.

Input: Raw biomechanical signals from the biosignal detection device.

Output: Preprocessed motion data.

The terminal applies noise filtering and normalization to the input data using data processing software, such as NumPy. The terminal also formats the data into a standardized structure suitable for further analysis.

### Step 3

The terminal transmits the preprocessed motion data to the server over a secured network connection.

Input: Preprocessed motion data, user identifier information, and time stamp.

Output: Data packet sent to the server.

The terminal generates a data packet containing the cleaned and formatted motion data, attaches metadata, and sends it via HTTPS or WebSocket to the server for analysis.

### Step 4

The server analyzes the preprocessed motion data using a generative AI model implemented with TensorFlow or Keras.

Input: Preprocessed motion data from the terminal.

Output: Motion analysis result (for example, indication of dangerous, inappropriate, or safe movement).

The server inputs the received data into the trained AI model, which evaluates whether the current movement is compliant with safety standards or identifies risky or inappropriate activity.

### Step 5

The server acquires the user's emotional information from connected devices, such as cameras and microphones.

Input: Real-time facial images and voice recordings from the terminal.

Output: Extracted facial and audio features for emotion analysis.

The server collects a video or image stream for facial expression recognition and an audio stream for voice tone analysis. The server uses libraries like OpenCV and PyTorch to extract features relevant to emotion detection.

### Step 6

The server analyzes the emotional features using the emotion analysis engine.

Input: Extracted emotional features (facial and vocal).

Output: User's emotional state (such as anxious, stressed, calm, or irritated).

The server processes the extracted features and classifies the user's emotional condition by applying emotion recognition algorithms.

### Step 7

The server generates a prompt sentence by combining the motion analysis result and the emotional state.

Input: Motion analysis result and emotional state.

Output: Tailored instruction sentence (prompt sentence).

The server uses predefined rules or AI-driven text generation methods to select or create an instruction that directly addresses the current safety and emotional needs of the user.

### Step 8

The server sends the generated prompt sentence to the terminal.

Input: Instruction sentence and supplementary metadata.

Output: Message packet transmitted to the terminal.

The server assembles a communication containing the instruction and sends it to the terminal for user notification.

### Step 9

The terminal notifies the user using its display and speakers.

Input: Instruction sentence.

Output: Visual and/or spoken notification to the user.

The terminal presents the instruction sentence on its display in readable text and uses text-to-speech software such as pyttsx3 to convert the text into audio, broadcasting it through the speaker.

### Step 10

The user receives the notification and responds by adjusting their physical actions or calming themselves.

Input: Visual or auditory instruction.

Output: Modified user behavior that aligns with the provided guidance.

The user observes or hears the instruction and, for example, changes their posture to a safer one or takes a break as instructed.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

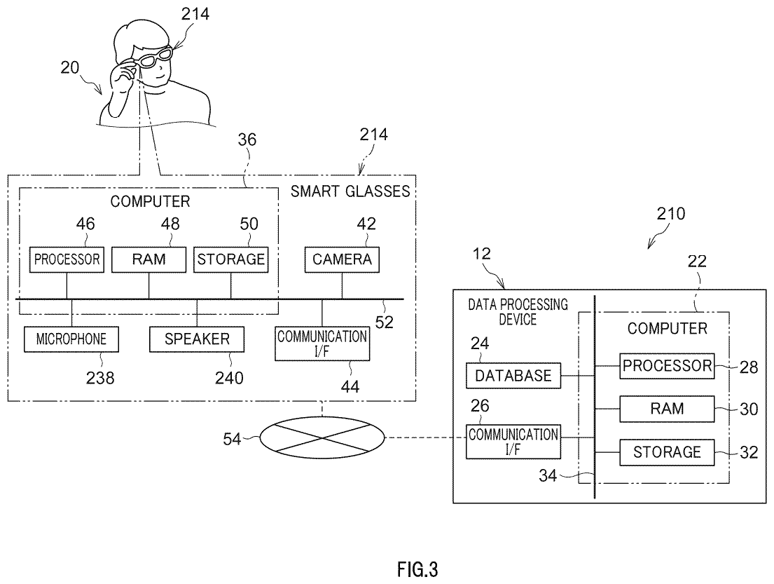

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

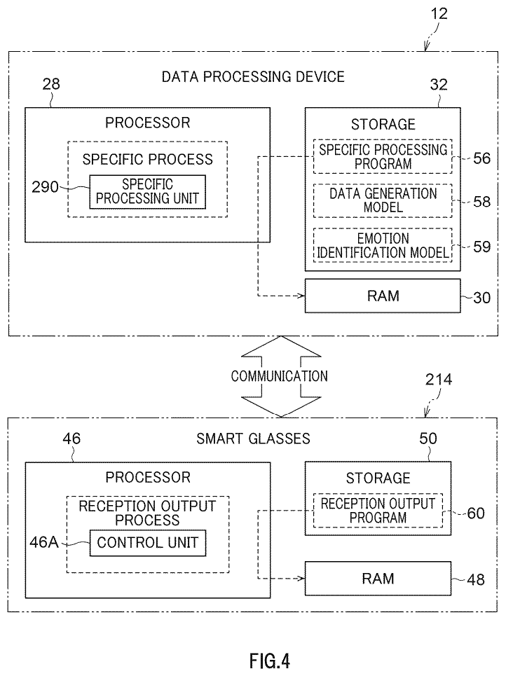

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### EXAMPLE 1

Explanation of flow will be omitted due to being similar to a flow of the specific processing in Example 1 as described in the first exemplary embodiment above.

### APPLICATION EXAMPLE 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### APPLICATION EXAMPLE 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

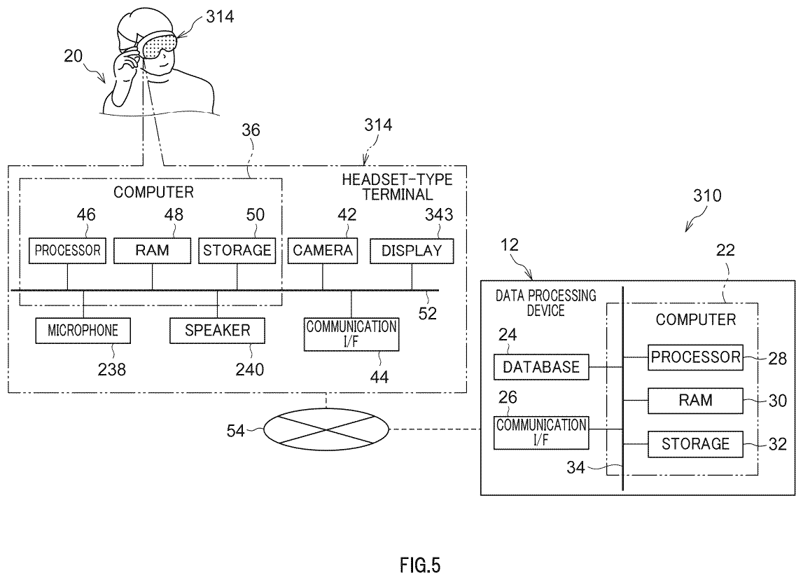

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

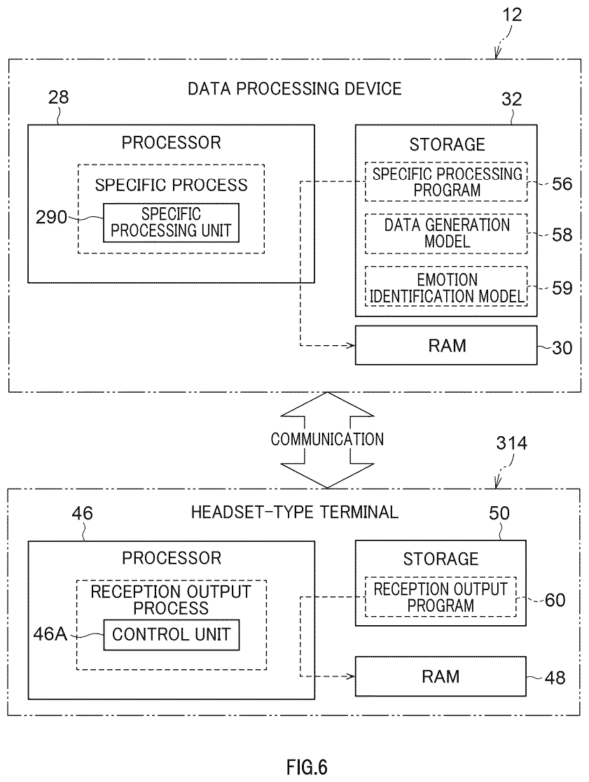

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### EXAMPLE 1

Explanation of flow will be omitted due to being similar to a flow of the specific processing in Example 1 as described in the first exemplary embodiment above.

### APPLICATION EXAMPLE 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### APPLICATION EXAMPLE 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

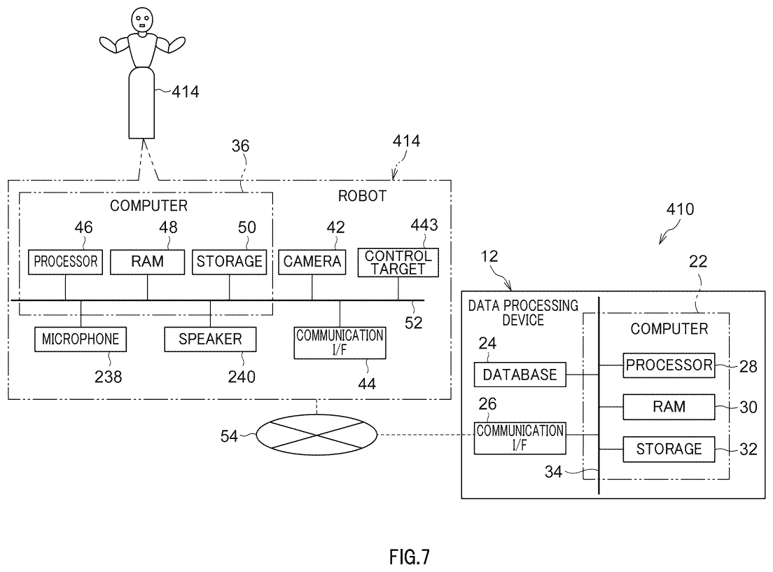

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

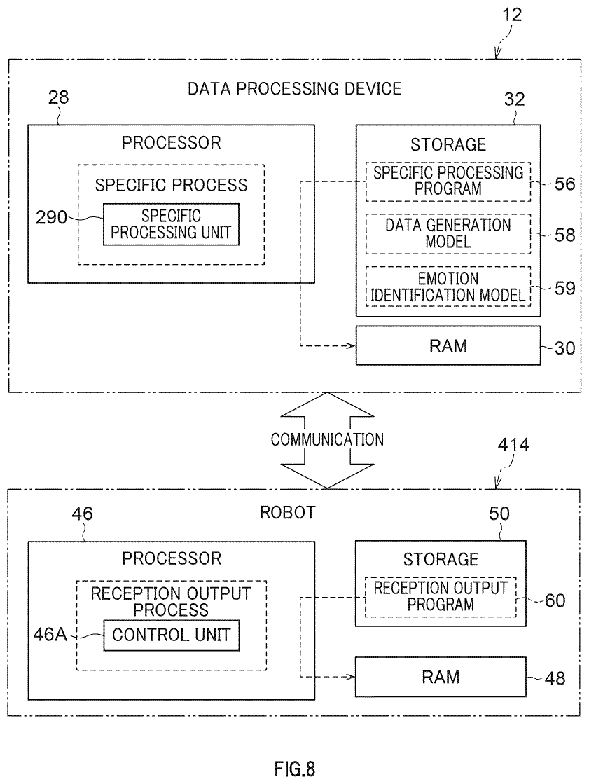

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### EXAMPLE 1

Explanation of flow will be omitted due to being similar to a flow of the specific processing in Example 1 as described in the first exemplary embodiment above.

### APPLICATION EXAMPLE 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### APPLICATION EXAMPLE 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

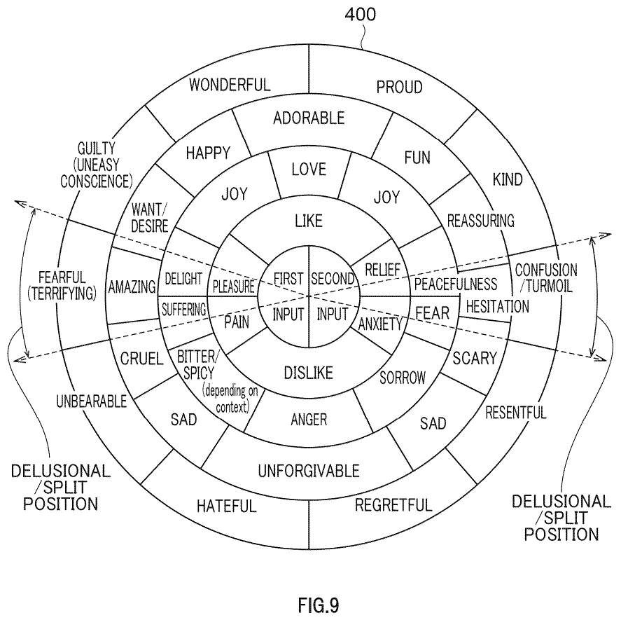

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety.

Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

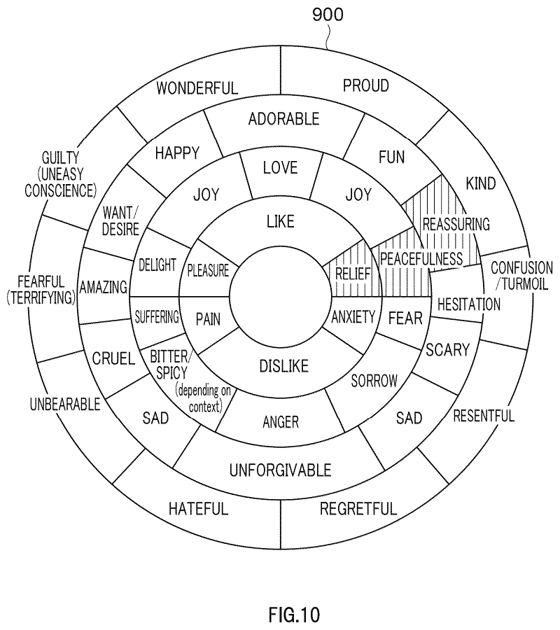

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### EXAMPLE 1

### Supplementary 1

A system comprising a processor,
wherein the processor is configured to
receive body motion information acquired from a biological function information acquisition device and preprocess said information by a signal processing device,
remove noise components and standardize the preprocessed body motion information,
analyze the standardized body motion information employing a generative intelligence processing device capable of processing time-series data,
generate instruction content when the generative intelligence processing device detects a hazardous state or inappropriate action,
transmit the instruction content to a terminal device, and notify the user through a display device or an audio output device,
and acquire and record response information from the user via the signal processing device.

### Supplementary 2

The system according to supplementary 1,
wherein the processor is configured to
cause the biological function information acquisition device to detect user motion information in real-time using a body-mounted measurement element and transmit the information to the signal processing device.

### Supplementary 3

The system according to supplementary 1,
wherein the processor is configured to
use a learning model including a recurrent artificial neural network as the generative intelligence processing device and dynamically generate instruction sentences based on the analysis result.

### APPLICATION EXAMPLE 1

### Supplementary 1

A system comprising a processor,
wherein the processor is configured to
preprocess time-series information acquired from a biometric measurement device,
analyze the preprocessed time-series information using a generative artificial intelligence model to detect an abnormal state or risk condition,
generate a prompt sentence for input to the generative artificial intelligence model,
generate a notification content based on the analysis result and emotion identification information,
output the notification content to a user by using at least one of a visual output unit and an audio output unit, and
recognize an emotional state of the user by using feature information from an emotion estimation device and provide a recognition result to generate the notification content.

### Supplementary 2

The system according to supplementary 1,
wherein the processor is configured to obtain real-time biometric activity information or physical activity information of the user from the measurement device and transmit the information to a terminal device.

### Supplementary 3

The system according to supplementary 1,
wherein the processor is configured to include a deep learning model including a recurrent neural network as the generative artificial intelligence model.

### EXAMPLE 2

### Supplementary 1

A system comprising a processor,
wherein the processor is configured to
preprocess motion information and emotion information acquired from a biometric information acquisition device,
analyze the preprocessed motion information using a generative machine learning model to predict abnormalities or risks in the operation,
generate instruction content for a user by adjusting such instructions based on both the analysis result from the generative machine learning model and a real-time recognized emotional state, and
notify the instruction content to the user via an information terminal.

### Supplementary 2

The system according to supplementary 1,
wherein the processor is configured to
cause the biometric information acquisition device to continuously detect current biometric information of the user and transmit the information to the information terminal.

### Supplementary 3

The system according to supplementary 1,
wherein the processor is configured to
utilize a model including a neural network for time-series data analysis as the generative machine learning model.

### APPLICATION EXAMPLE 2

### Supplementary 1

A system comprising a processor,
wherein the processor is configured to
preprocess motion information acquired from a biosignal detection device,
analyze the preprocessed motion information using a generative artificial intelligence model to detect inappropriate operation or risk,
acquire user emotional information and analyze the emotional information using an emotion analysis engine,
generate and output an instruction sentence to a user based on both results of motion analysis by the generative artificial intelligence model and emotional analysis by the emotion analysis engine, and
notify the user of the instruction sentence via an output device by a visual or auditory modality.

### Supplementary 2

The system according to supplementary 1,
wherein the processor is configured to acquire real-time motion information from a biosignal detection device and transmit the motion information to a terminal device.

### Supplementary 3

The system according to supplementary 1,
wherein the generative artificial intelligence model used by the processor includes a recurrent neural network as a learning model.

What is claimed is:

1. A system comprising a processor,
wherein the processor is configured to:
preprocess motion data received from biomechanical sensors,
analyze the preprocessed motion data using a generative artificial intelligence to detect inappropriate movements or risks, and
provide instructions to a user based on analysis results by the generative artificial intelligence.

2. The system of claim 1, wherein the biomechanical sensors are configured to detect real-time movements of the user and transmit the motion data to a terminal.

3. The system of claim 1, wherein the generative artificial intelligence utilizes a model including a recurrent neural network.

4. The system of claim 1, wherein the instructions to the user are provided through at least one of a visual display and an audio notification.

5. The system of claim 1, wherein the determination of inappropriate movement is made by comparing the motion data to predefined criteria.
